(19) United States
(12) Patent Application Publication
(10) Pub. No.: US 2017/0353994 A1
(43) Pub. Date: Dec. 7, 2017

(54) SELF-CENTERING PEDESTAL HEATER

(71) Applicant: Applied Materials, Inc., Santa Clara, CA (US)

(72) Inventors: Sam H. KIM, San Ramon, CA (US); Yuxing ZHANG, Santa Clara, CA (US); Milind GADRE, Santa Clara, CA (US); Sanjeev BALUJA, Campbell, CA (US)

(21) Appl. No.: 15/174,526

(22) Filed: Jun. 6, 2016

(51) Int. Cl. H05B 1/02; H05B 3/24

(52) U.S. Cl. CPC H05B 1/0233; H05B 3/24

(57) ABSTRACT

A pedestal is provided that includes a body, a heater embedded in the body, a support pocket formed within the body having a surface disposed in a first plane, a peripheral surface disposed in a second plane surrounding the support pocket, and a plurality of centering tabs positioned between the support pocket and the peripheral surface, each of the centering tabs having a surface disposed in a third plane that is between both of the first and second planes.

### BACKGROUND

### Field

Embodiments disclosed herein generally relate to a pedestal heater for forming films on substrates, such as semiconductor substrate and, more specifically, a pedestal heater that centers a substrate for a film stack formation process.

### Description of the Related Art

Semiconductor processing involves a number of different chemical and physical processes enabling minute integrated circuits to be created on a substrate. Layers of materials which make up the integrated circuit are created by chemical vapor deposition, physical vapor deposition, epitaxial growth, and the like. Some of the layers of material are patterned using photoresist masks and wet or dry etching techniques. The substrate utilized to form integrated circuits may be silicon, gallium arsenide, indium phosphide, glass, or other appropriate material.

A pedestal heater is typically utilized to support a substrate relative to a showerhead in a chamber in a deposition process. Some of the conventional pedestal heaters include a pocket formed in a surface thereof where the substrate may be positioned. However, the typical pocket is sized greater than the substrate such that the substrate may move within the pocket and/or a gap between the edge of the substrate and an inner surface of the pocket varies. This errant positioning of the substrate negatively affects film uniformity.

Therefore, what is needed is a pedestal that effectively centers the substrate and prevents movement thereon.

### SUMMARY

A method and apparatus for a heated pedestal is provided. In one embodiment, a pedestal is provided that includes a body, a heater embedded in the body, a support pocket formed within the body having a surface disposed in a first plane, a peripheral surface disposed in a second plane surrounding the support pocket, and a plurality of centering tabs positioned between the support pocket and the peripheral surface, each of the centering tabs having a surface disposed in a third plane that is between both of the first and second planes.

In another embodiment, a pedestal is provided that includes a body, an embedded heater disposed in the body, a support pocket formed within the body having a surface disposed in a first plane, a peripheral surface disposed in a second plane surrounding the support pocket, and a plurality of centering tabs positioned between the support pocket and the peripheral surface, each of the centering tabs having a surface disposed in a third plane that is between both of the first and second planes, and a gap having a width that is substantially the same is formed between each of the centering tabs.

In another embodiment, a pedestal is provided that includes a body having a heating element embedded therein, a support pocket formed within the body having a surface disposed in a first plane extending a first distance from a longitudinal axis of the body, a peripheral surface disposed in a second plane having a wall surrounding the support pocket, the wall extending a second distance from the longitudinal axis of the body that is greater than the first distance, and a plurality of centering tabs positioned between the first and second distances, each of the centering tabs having a surface disposed in a third plane that is between both of the first and second planes, wherein the first plane and the second plane have a parallelism of 0.002 inches or less.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting of its scope, for the embodiments disclosed herein may admit to other equally effective embodiments.

FIG. 1 is a partial cross sectional view of a plasma system.

FIG. 2A is an isometric top view of one embodiment of a pedestal that may be utilized in the plasma system of FIG. 1.

FIG. 2B is a cross-sectional view of the susceptor body along lines 2B-2B of FIG. 2A.

FIG. 2C is an enlarged detail view of one of the centering tabs of FIG. 2A.

FIG. 3A is a cross-sectional view of a portion of the susceptor body showing another embodiment of a centering tab that may be used with the pedestal shown in FIG. 2A as one or more of the centering tabs.

FIG. 3B is an elevation view of the centering tab along line 3B-3B of FIG. 2A.

FIG. 4 is a cross-sectional view of a portion of the susceptor body showing another embodiment of a centering tab that may be used with the pedestal shown in FIG. 2A as one or more of the centering tabs.

FIG. 5 is a cross-sectional view of a portion of the susceptor body showing another embodiment of a centering tab that may be used with the pedestal shown in FIG. 2A as one or more of the centering tabs.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present disclosure are illustratively described below in reference to plasma chambers, although embodiments described herein may be utilized in other chamber types and in multiple processes. In one embodiment, the plasma chamber is utilized in a plasma enhanced chemical vapor deposition (PECVD) system. Examples of PECVD systems that may be adapted to benefit from the disclosure include a PRODUCER® SE CVD system, a PRODUCER® GT™ CVD system or a DXZ® CVD system, all of which are commercially available from Applied Materials, Inc., Santa Clara, Calif.

The PRODUCER® SE CVD system chamber has two isolated processing regions that may be used to deposit thin films on substrates, such as conductive films, oxide films such as silicon oxide films, nitride films, polysilicon films, carbon-doped silicon oxides and other materials. Although the exemplary embodiment includes two processing regions, it is contemplated that embodiments disclosed herein may be used to advantage in systems having a single processing region or more than two processing regions. It is also contemplated that embodiments disclosed herein may be utilized to advantage in other plasma chambers, including etch chambers, ion implantation chambers, plasma treatment chambers, and in resist stripping chambers, among others. It is further contemplated that embodiments disclosed herein may be utilized to advantage in plasma processing chambers available from other manufacturers.

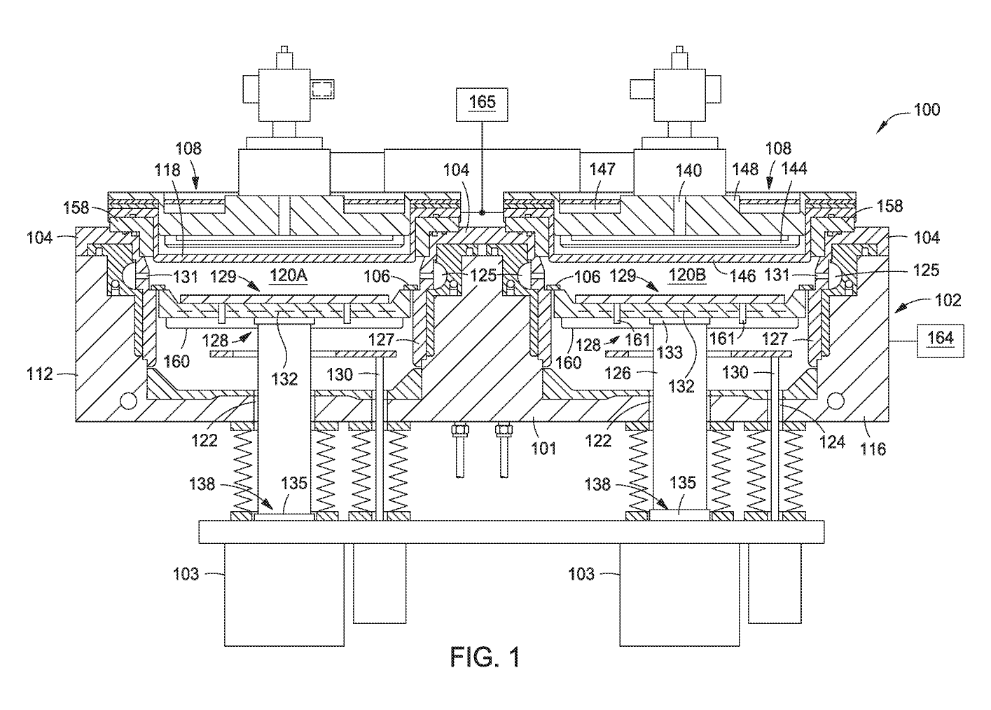

FIG. 1 is a partial cross sectional view of a plasma system 100. The plasma system 100 generally comprises a chamber body 102 having sidewalls 112, a bottom wall 116, and an interior sidewall 101 defining a pair of processing regions 120A and 120B. Each of the processing regions 120A-120B is similarly configured, and for the sake of brevity, only components in the processing region 120B are described.

A pedestal 128 is disposed in the processing region 120B through a passage 122 formed in the bottom wall 116 in the system 100. The pedestal 128 provides a heater adapted to support a substrate 129 on the upper surface thereof. The pedestal 128 may include heating elements 132, for example resistive heating elements, to heat and control the substrate temperature at a desired process temperature. Alternatively, the pedestal 128 may be heated by a remote heating element, such as a lamp assembly.

The pedestal 128 is coupled by a flange 133 to a stem 126. The stem 126 may couple the pedestal 128 to a power outlet or power box 103. The power box 103 may include a drive system that controls the elevation and movement of the pedestal 128 within the processing region 120B. The stem 126 may also contain electrical power interfaces to provide electrical power to the pedestal 128. The power box 103 may also include interfaces for electrical power and temperature indicators, such as a thermocouple interface. The stem 126 also includes a base assembly 138 adapted to detachably couple to the power box 103 thereto. A circumferential ring 135 is shown above the power box 103. In one embodiment, the circumferential ring 135 is a shoulder adapted as a mechanical stop or land configured to provide a mechanical interface between the base assembly 138 and the upper surface of the power box 103.

A rod 130 is disposed through a passage 124 formed in the bottom wall 116 of the processing region 1206 and may be utilized to position substrate lift pins 161 disposed through the pedestal 128. The substrate lift pins 161 selectively space the substrate 129 from the pedestal to facilitate exchange of the substrate 129 with a robot (not shown) utilized for transferring the substrate 129 into and out of the processing region 120B through a substrate transfer port 160.

A chamber lid 104 is coupled to a top portion of the chamber body 102. The lid 104 may accommodate one or more gas distribution systems 108 coupled thereto. The gas distribution system 108 includes a gas inlet passage 140 which delivers reactant and cleaning gases through a dual-channel showerhead 118 into the processing region 1206. The dual-channel showerhead 118 includes an annular base plate 148 having a blocker plate 144 disposed intermediate to a faceplate 146. A radio frequency (RF) source 165 may be coupled to the dual-channel showerhead 118. The RF source 165 powers the dual-channel showerhead 118 to facilitate generating a plasma region between the faceplate 146 of the dual-channel showerhead 118 and the pedestal 128. In one embodiment, the RF source 165 may be a high frequency radio frequency (HFRF) power source, such as a 13.56 MHz RF generator. In another embodiment, RF source 165 may include a HFRF power source and a low frequency radio frequency (LFRF) power source, such as a 300 kHz RF generator. Alternatively, the RF source may be coupled to other portions of the chamber body 102, such as the pedestal 128, to facilitate plasma generation. A dielectric isolator 158 may be disposed between the lid 104 and the dual-channel showerhead 118 to prevent conducting RF power to the lid 104. A shadow ring 106 may be disposed on the periphery of the pedestal 128 that engages the pedestal 128.

Optionally, a cooling channel 147 may be formed in the annular base plate 148 of the gas distribution system 108 to cool the annular base plate 148 during operation. A heat transfer fluid, such as water, ethylene glycol, a gas, or the like, may be circulated through the cooling channel 147 such that the base plate 148 may be maintained at a predefined temperature.

A liner assembly 127 may be disposed within the processing region 120B in very close proximity to the sidewalls 101, 112 of the chamber body 102 to prevent exposure of the sidewalls 101, 112 to the processing environment within the processing region 120B. The liner assembly 127 includes a circumferential pumping cavity 125 that may be coupled to a pumping system 164 configured to exhaust gases and byproducts from the processing region 120B and control the pressure within the processing region 120B. A plurality of exhaust ports 131 may be formed on the liner assembly 127. The exhaust ports 131 are configured to allow the flow of gases from the processing region 120B to the circumferential pumping cavity 125 in a manner that promotes processing within the system 100.

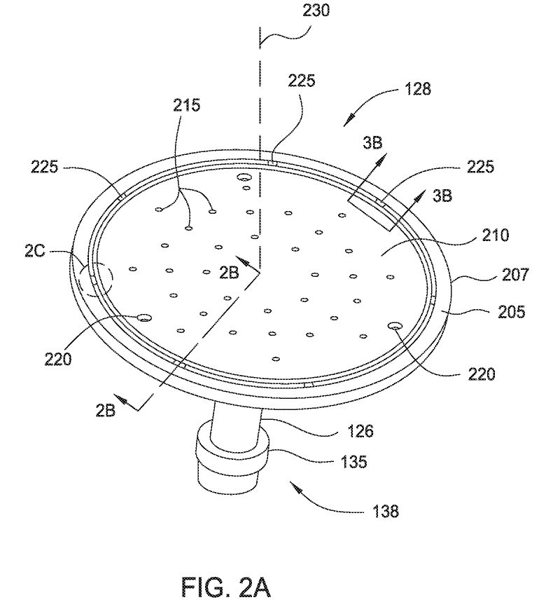

FIG. 2A is an isometric top view of one embodiment of a pedestal 128 that is utilized in the plasma system 100. The pedestal 128 includes a stem 126 and the base assembly 138 opposite a peripheral surface 205 of a susceptor body 207. In one embodiment, the stem 126 is configured as a tubular member or hollow shaft. The substrate support 205 includes a substrate receiving surface or support pocket 210 that is substantially planar, or may include a concave or slightly curved surface. The support pocket 210 may be adapted to support a 200 millimeter (mm) substrate, a 300 mm substrate, or a 450 mm substrate. In one embodiment, the support pocket 210 includes a plurality of structures 215, which may be bumps or protrusions extending above the plane of the support pocket 210. The height of each of the plurality of structures 215 are substantially equal to provide a substantially planar substrate receiving plane or surface that is slightly elevated or spaced-away from a surface of the support pocket 210. In one embodiment, each of the structures 215 are formed of or coated with a material that is different from the material of the support pocket 210. The support pocket 210 also includes a plurality of openings 220 formed therethrough that are adapted to receive a lift pin 161 (FIG. 1).

In one embodiment, the susceptor body 207 and stem 126 are made of a conductive metallic material while the base assembly 138 is made of a combination of a conductive metallic material and an insulative material. Fabricating the susceptor body 207 from a conductive metallic material serves to shield an embedded heater (not shown in this view) from RF power. This increases the efficiency and lifetime of the pedestal 128, which decreases cost of ownership.

In one embodiment, the susceptor body 207 and stem 126 are made solely of an aluminum material, such as an aluminum alloy or a ceramic material. In a specific embodiment, both of the susceptor body 207 and stem are made of AlN. In one embodiment, the susceptor body 207 is made from a ceramic material while each of the structures 215 disposed on the support pocket 210 are made of or coated with a ceramic material, such as aluminum oxide.

In some embodiments, the support pocket 210 includes a plurality of centering tabs 225. Each of the centering tabs 225 may be positioned to extend radially inward from the peripheral surface 205 (e.g., toward a longitudinal axis 230 of the pedestal 128). The number of centering tabs 225 are not limited to the quantity shown in the drawing and may be three or more, such as four, five, six, seven, eight or more. In some embodiments, the centering tabs 225 are positioned opposite to each other, such as with an even number of centering tabs 225. In other embodiments, the centering tabs 225 are spaced apart by substantially equal intervals, such as about 120 degrees where there are three centering tabs 225, or about 72 degrees where there are five centering tabs 225.

FIG. 2B is a cross-sectional view of the susceptor body 207 along lines 2B-2B of FIG. 2A. One embodiment of a centering tab 225 is shown in FIG. 2A. In this embodiment, the centering tab 225 includes a surface 235 in a plane 240 that is intermediate to a plane 245 of a surface 250 of the support pocket 210 and a plane 255 of the peripheral surface 205. A parallelism between the plane 255 and the plane 245 may be about 0.002 inches or less. The centering tab 225 includes a sloped surface 260 intersecting the surface 250 of the support pocket 210 and the surface 235. The intersection of the sloped surface 260 with the surface 235 as well as the intersection of the sloped surface 260 with the surface 250 of the support pocket 210 generally defines a substrate receiving area where an edge of a substrate (not shown) may reside during processing. In some embodiments, the angle α of the sloped surface 260 relative to the surface 250 of the support pocket 210 may be about 50 degrees to about 70 degrees, such as about 60 degrees.

In one example, when a 300 mm substrate is utilized, a radial length 265 between the longitudinal axis 230 and the intersection of the sloped surface 260 with the surface 235 may be about 5.92 inches (about 150.3 mm). As such, the edge of the 300 mm substrate may contact the sloped surface 260 and fall to a position toward the surface 250 of the support pocket 210. At some position between the plane 240 and the plane 245 of the surface 250 of the support pocket 210, a diameter that is substantially equal to the diameter of the substrate is defined (e.g., about +/−6 mm). For example, the intersection of the sloped surface 260 with the surface 250 of the support pocket 210 may include a radial length 268 of about 5.08 inches (about 147.3 mm) in some embodiments. As such, the substrate is centered relative to the longitudinal axis 230 of the pedestal 128, and may be in thermal communication with the susceptor body 207 such that thermal energy may heat the substrate uniformly. In addition, the elevation and/or parallelism of the substrate relative to the peripheral surface 205 (e.g., the plane 255) is controlled. This provides uniform conditions for deposition which increases deposition uniformity.

The support pocket 210 may also include a sloped surface 270 interfacing with the surface 235 and opposing the sloped surface 260. In some embodiments, the angle of the sloped surface 270 may be substantially equal to the angle α of the sloped surface 260 such that the sloped surface 270 and the sloped surface 260 are parallel (e.g., a parallelism of about 0.005 inches or less). A length 272 of the surface 235 in the radial direction as shown in FIG. 2B may be about 0.01 inches (0.25 mm) to about 0.03 inches (0.76 mm), such as about 0.02 inches (0.51 mm).

A height or distance 246 from the surface 250 of the support pocket 210 (e.g., the plane 245) to the surface 235 (e.g., the plane 240) may be about 0.02 inches to about 0.03 inches (0.51 mm to 0.76 mm). A height or distance 248 between the surface 235 (e.g., the plane 240) to the peripheral surface 205 (e.g., the plane 245) may be about 0.04 inches (about 1 mm).

FIG. 2C is an enlarged detail view of one of the centering tabs 225 of FIG. 2A. The sloped surface 270 is more clearly shown in relation to the centering tab 225. The sloped surface 270 may occupy portions of the support pocket 210 where no centering tabs 225 are positioned as well as encompass the centering tabs 225. A radial length 275, measured between the longitudinal axis 230 of the pedestal 128 and an intersection 274 of the surface 250 of the support pocket 210 and the sloped surface 270, may be about 5.94 inches (150.88 mm) according to this embodiment.

In one embodiment, a gap or channel 276, formed between the centering tabs 225 has substantially the same width (e.g., +/−0.5 mm measured between the intersection 274 and the sloped surface 260) about the entire susceptor body 207 which provides uniform conditions for deposition processes.

A length 280 of the sloped surface 260 in a direction orthogonal to the longitudinal axis 230 of the pedestal 128 may be about 0.2 inches (5 mm) to about 0.07 inches (1.7 mm), such as about 0.15 inches (3.8 mm).

The configuration of the susceptor body 207 having the centering tabs 225 and the sloped surface 270 surrounding the support pocket 210 provides centering of a substrate relative to the longitudinal axis 230 of the pedestal 128. Additionally, height of the substrate relative to the surface 250 of the support pocket 210 is controlled. This provides repeatability, prevents movement of the substrate during processing (via pressure changes, for example), and provides a controlled gap between the edge of the substrate and the peripheral surface 205 of the susceptor body 207. One or more of the above described benefits provides greater uniformity during a deposition or etch process.

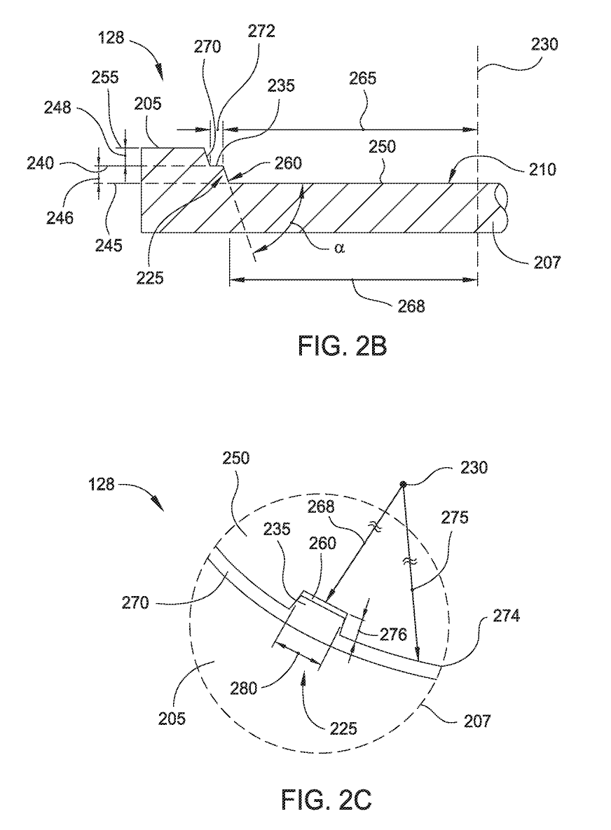

FIG. 3A is a cross-sectional view of a portion of the susceptor body 207 showing another embodiment of a centering tab 300 that may be used with the pedestal 128 shown in FIG. 2A as one or more of the centering tabs 225.

The centering tab 300 according to this embodiment is substantially the same as the centering tab 225 of FIG. 2B with the following exceptions. A radial length 305 between an intersection 310 of the surface 250 of the support pocket 210 and the longitudinal axis 230 of the pedestal 128 may be about 5.92 inches (150.3 mm). In addition, an angle α of the sloped surface 270 relative to the peripheral surface 205 (as well as the surface 250 of the support pocket 210) may be about 50 degrees to about 70 degrees, such as about 60 degrees. Additionally, a height or distance 315 between the surface 235 (e.g., the plane 240) to the peripheral surface 205 (e.g., the plane 245) may be about 0.09 inches (about 2.2 mm). An intersection 320 where the sloped surface 270 meets the peripheral surface 205 may include a radius of about 0.05 inches to about 0.07 inches (1.2 mm to 1.7 mm).

FIG. 3B is an elevation view of the centering tab 300 along line 3B-3B of FIG. 2A. The centering tab 300 includes the sloped surface 260 and has two compound sloped surfaces 325 (in an X-Y plane as well as a Y-Z plane) that transition from the sloped surface 260 into the sloped surface 270. The sloped surfaces 325 in the X-Y plane may be formed along a radius relative to a length thereof. In addition, the compound sloped surfaces 325 in the Y-Z plane include an angle 330 that may be about 50 degrees to about 70 degrees, such as about 60 degrees.

In one example, when a 300 mm substrate is utilized, the edge of the 300 mm substrate may contact the sloped surface 260 and fall to a position adjacent to the intersection 310. As such, the substrate is centered relative to the longitudinal axis 230 of the pedestal 128, and may be in thermal communication with the susceptor body 207 such that thermal energy may heat the substrate uniformly. In addition, the elevation and/or parallelism of the substrate relative to the peripheral surface 205 (e.g., the plane 255) is controlled. This provides uniform conditions for deposition which increases deposition uniformity.

The configuration of the susceptor body 207 having the centering tabs 300 and the sloped surface 270 surrounding the support pocket 210 provides centering of a substrate relative to the longitudinal axis 230 of the pedestal 128. Additionally, height of the substrate relative to the surface 250 of the support pocket 210 is controlled. This provides repeatability, prevents movement of the substrate during processing (via pressure changes, for example), and provides a controlled gap between the edge of the substrate and the peripheral surface 205 of the susceptor body 207. One or more of the above described benefits provides greater uniformity during a deposition or etch process.

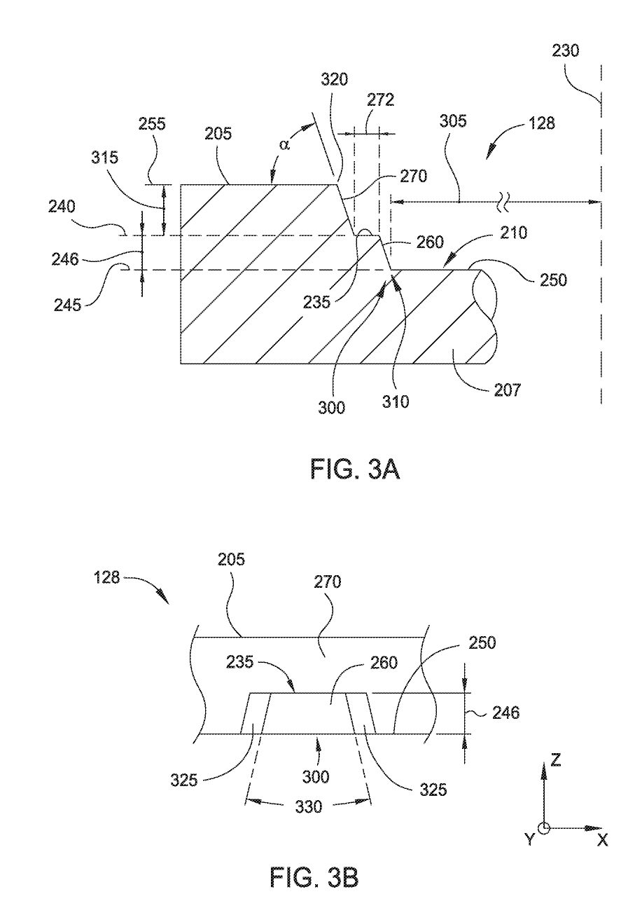

FIG. 4 is a cross-sectional view of a portion of the susceptor body 207 showing another embodiment of a centering tab 400 that may be used with the pedestal 128 shown in FIG. 2A as one or more of the centering tabs 225.

The centering tab 400 according to this embodiment is substantially the same as the centering tab 225 of FIG. 2B with the following exceptions. The centering tab 400 according to this embodiment includes a peripheral wall 405 that interfaces with the peripheral surface 205 and the surface 235. The peripheral wall 405 and the surface 235 may circumscribe or surround the entire support pocket 210. A radial length 410 between the peripheral wall 405 and the longitudinal axis 230 of the pedestal 128 may be about 5.94 inches (150.8 mm). A radial length 415 of the surface 235 may be about 0.03 inches to about 0.05 inches (0.7 mm to 1.25 mm), such as about 0.04 inches (1.02 mm). A depth 420 (or length orthogonal to the plane 255) may be about 0.01 inches (0.254 mm) to about 0.006 inches (0.152 mm), such as about 0.008 inches (0.203 mm).

In one example, when a 300 mm substrate is utilized, the edge of the 300 mm substrate may contact the sloped surface 260 and fall to a position adjacent to the surface 250 of the support pocket 210. As such, the substrate is centered relative to the longitudinal axis 230 of the pedestal 128, and may be in thermal communication with the susceptor body 207 such that thermal energy may heat the substrate uniformly. In addition, the elevation and/or parallelism of the substrate relative to the peripheral surface 205 (e.g., the plane 255) is controlled. This provides uniform conditions for deposition which increases deposition uniformity.

The configuration of the susceptor body 207 having the centering tabs 400 and the peripheral wall 405 surrounding the support pocket 210 provides centering of a substrate relative to the longitudinal axis 230 of the pedestal 128. Additionally, height of the substrate relative to the surface 250 of the support pocket 210 is controlled. This provides repeatability, prevents movement of the substrate during processing (via pressure changes, for example), and provides a controlled gap between the edge of the substrate and the peripheral surface 205 of the susceptor body 207. One or more of the above described benefits provides greater uniformity during a deposition or etch process.

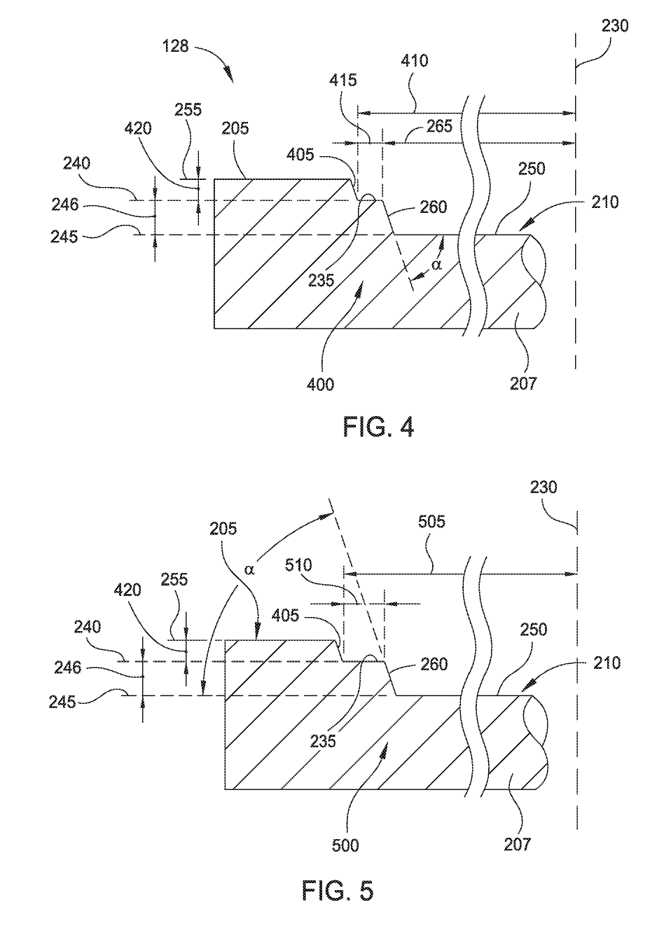

FIG. 5 is a cross-sectional view of a portion of the susceptor body 207 showing another embodiment of a centering tab 500 that may be used with the pedestal 128 shown in FIG. 2A as one or more of the centering tabs 225.

The centering tab 500 according to this embodiment is substantially the same as the centering tab 225 of FIG. 4 with the following exceptions. The centering tab 500 according to this embodiment has a radial length 505 between the peripheral wall 405 and the longitudinal axis 230 of the pedestal 128 of about 5.97 inches (151.64 mm). A radial length 510 of the surface 235 may be about 0.07 inches to about 0.09 inches (1.78 mm to 2.29 mm), such as about 0.08 inches (2.03 mm). A depth 420 (or length orthogonal to the plane 255) may be about 0.01 inches (0.254 mm) to about 0.006 inches (0.152 mm), such as about 0.008 inches (0.203 mm).

In one example, when a 300 mm substrate is utilized, the edge of the 300 mm substrate may contact the sloped surface 260 and fall to a position adjacent to the surface 250 of the support pocket 210. As such, the substrate is centered relative to the longitudinal axis 230 of the pedestal 128, and may be in thermal communication with the susceptor body 207 such that thermal energy may heat the substrate uniformly. In addition, the elevation and/or parallelism of the substrate relative to the peripheral surface 205 (e.g., the plane 255) is controlled. This provides uniform conditions for deposition which increases deposition uniformity.

The configuration of the susceptor body 207 having the centering tabs 500 and the peripheral wall 405 surrounding the support pocket 210 provides centering of a substrate relative to the longitudinal axis 230 of the pedestal 128. Additionally, height of the substrate relative to the surface 250 of the support pocket 210 is controlled. This provides repeatability, prevents movement of the substrate during processing (via pressure changes, for example), and provides a controlled gap between the edge of the substrate and the peripheral surface 205 of the susceptor body 207. One or more of the above described benefits provides greater uniformity during a deposition or etch process.

While the foregoing is directed to embodiments of the disclosure, other and further embodiments of the disclosure may be devised without departing from the basic scope thereof, and the scope thereof is determined by the claims that follow.

What is claimed is:

1. A pedestal, comprising:
a body;
a heater embedded in the body;
a support pocket formed within the body having a surface disposed in a first plane;
a peripheral surface disposed in a second plane surrounding the support pocket; and
a plurality of centering tabs positioned between the support pocket and the peripheral surface, each of the centering tabs having a surface disposed in a third plane that is between both of the first and second planes.

2. The pedestal of claim 1, wherein the first plane and the second plane have a parallelism of 0.002 inches or less.

3. The pedestal of claim 1, wherein each of the centering tabs have a sloped surface expending between the second and third planes.

4. The pedestal of claim 1, further comprising a channel between the peripheral surface and the surfaces of the centering tabs.

5. The pedestal of claim 4, wherein the channel surrounds the support pocket.

6. The pedestal of claim 5, wherein the channel has substantially the same width.

7. The pedestal of claim 4, wherein the channel includes a peripheral wall.

8. The pedestal of claim 7, wherein the peripheral wall is oriented orthogonally relative to the peripheral surface.

9. The pedestal of claim 7, wherein the peripheral wall is angled relative to the peripheral surface.

10. The pedestal of claim 9, wherein each of the centering tabs have a sloped surface expending between the second and third planes, and an angle of the sloped surface and an angle of the peripheral wall are substantially the same.

11. A pedestal, comprising:
a body;
an embedded heater disposed in the body;
a support pocket formed within the body having a surface disposed in a first plane;
a peripheral surface disposed in a second plane surrounding the support pocket; and
a plurality of centering tabs positioned between the support pocket and the peripheral surface, each of the centering tabs having a surface disposed in a third plane that is between both of the first and second planes, and a gap having a width that is substantially the same is formed between each of the centering tabs.

12. The pedestal of claim 11, wherein the first plane and the second plane have a parallelism of 0.002 inches or less.

13. The pedestal of claim 11, wherein the gap includes a peripheral wall.

14. The pedestal of claim 13, wherein the peripheral wall is oriented orthogonally relative to the peripheral surface.

15. The pedestal of claim 13, wherein the peripheral wall is angled relative to the peripheral surface.

16. The pedestal of claim 15, wherein each of the centering tabs have a sloped surface expending between the second and third planes, and an angle of the sloped surface and an angle of the peripheral wall are substantially the same.

17. A pedestal, comprising:
a body having a heating element embedded therein;
a support pocket formed within the body having a surface disposed in a first plane extending a first distance from a longitudinal axis of the body;
a peripheral surface disposed in a second plane having a wall surrounding the support pocket, the wall extending a second distance from the longitudinal axis of the body that is greater than the first distance; and
a plurality of centering tabs positioned between the first and second distances, each of the centering tabs having a surface disposed in a third plane that is between both of the first and second planes, wherein the first plane and the second plane have a parallelism of 0.002 inches or less.

18. The pedestal of claim 17, wherein the wall comprises a sloped surface and defines a channel between each of the centering tabs.

19. The pedestal of claim 18, wherein the channel has substantially the same width.

20. The pedestal of claim 18, wherein an angled surface extends between the surface of each of the centering tabs and the surface of the support pocket, and the sloped surface of the wall and the angled surface are substantially parallel.
